(19) United States
(12) Patent Application Publication
(10) Pub. No.: US 2003/0038500 A1
(43) Pub. Date: Feb. 27, 2003

(54) Vehicle deck lid power operator

(76) Inventors: Michael Eugene Aubry, Shelby Township, MI (US); John Thomas Goscicki, Sterling Heights, MI (US); Anthony J. Sciarrotta, East Pointe, MI (US)

Correspondence Address: PATRICK M. GRIFFIN, DELPHI TECHNOLOGIES, INC., Legal Staff, P.O. Box 5052 Mail Code: 480-414-420, Troy, MI, 48007-5052, US

(21) Appl. No.: 09/934,939

(22) Filed: Aug. 22, 2001

(51) Int. Cl. B62D 25/12

(52) U.S. Cl. 296/76

(57) ABSTRACT

A compact and simple vehicle deck lid power operator wherein a reversible electric motor, pinion and curved rack cooperate with standard deck lid gooseneck hinge arm and support bracket components. The curved rack is fixedly on the bracket and has a curved row of rack gear teeth concentric with the hinge arm pivot deck lid axis. The motor unit is mounted in nested relation on the curved section of the gooseneck hinge arm with its output pinion in driving mesh with the rack gear teeth. Operation of the motor causes rotation of the pivot and travel thereof in a curved path along the rack teeth so that the gooseneck-supported motor unit forces the gooseneck hinge to pivot about its pivot axis to either open or close the deck lid.

### FIELD OF THE INVENTION

This invention relates generally to operating apparatus for motor vehicle deck lids and more particularly to apparatus for power opening and power closing a deck lid.

### BACKGROUND OF THE INVENTION

Typically the deck lid of a motor vehicle is opened and closed manually. Manual operation is difficult for many people, and if a deck lid is operated carelessly, damage to the deck lid and/or the latching mechanism for the deck lid may result. Although several proposals have been provided in the prior art for power operating vehicle deck lids, many require assembly of various components as they are installed on the vehicle, are somewhat bulky and occupy an undue amount of space within the confines of the vehicle, often involve a considerable number of parts and are somewhat expensive to manufacture, assemble and/or install in the vehicle.

### OBJECTS OF THE INVENTION

Accordingly, among the objects of the invention are to provide an improved apparatus for the power operation of a deck lid which is easier to manufacture and install due to the mechanism being adaptable to being provided as a subassembly with the deck lid hinge, which is compact in the overall dimensions of the assembly, that can be incorporated into the vehicle without any changes to the vehicle, requires fewer parts than hitherto required for power operators of deck lids, is composed of a relatively few simple parts, is rugged and durable in use, and easy to operate.

### SUMMARY OF THE INVENTION

In general, and by way of summary description and not by way of limitation, the present invention achieves one or more of the foregoing objects by providing a reversible electric motor, pinion and rack that can be installed onto and be supported by a standard deck lid gooseneck hinge component already customarily provided on the vehicle. Thus, in a typical installation the deck lid is hinged to the vehicle body by a pair of standard hinge assemblies comprising port and starboard gooseneck hinge arms. Each of these hinge arms has the usual curved section with one end of the curved section pivotally mounted to the vehicle body by a pivot connection provided in a support bracket fixed to the vehicle body. The gooseneck curved section terminates at its other end in a straight section that in turn is fastened to the interior side of the deck lid.

In accordance with the present invention a curved rack is fixedly supported on the hinge support bracket and has a curved row of rack gear teeth that extend in a curved path of constant radius concentric with the deck lid hinge pivot axis. A power unit including a reversible electric motor, a gear reduction drive and electromagnetic clutch are mounted as a unit in nested relation on the curved section of the gooseneck hinge arm and drive an output pinion gear that is in driving mesh with the rack gear teeth. Operation of the motor causes rotation of the pinion gear which then forces it to travel in a curved path along the rack teeth, thereby forcing the gooseneck hinge to swing about its pivot axis to either open or close the deck lid, depending upon the direction of rotation of the motor-driven pinion gear.

### BRIEF DESCRIPTION OF THE DRAWINGS

The foregoing as well as other objects, features and advantages of the present invention will be come apparent from the following detailed description, appended claims and accompanying drawings (which are to engineering scale unless otherwise indicated), wherein:

FIG. 1 is a fragmentary perspective view of the rear of an automotive passenger vehicle having apparatus for power opening and power closing a deck lid of the vehicle in accordance with an exemplary but preferred embodiment of the present invention.

FIG. 2 is a fragmentary elevational view of the deck lid power opening and power closing apparatus taken in the direction of the arrow 2 in FIG. 1 and illustrating in solid lines the closed position of the deck lid and power operating mechanism, the open position of these components being shown in phantom.

FIG. 3 is a side elevational view of the power operating mechanism and associated gooseneck hinge arm and support bracket shown as a separate subassembly, as viewed from the side opposite that seen in FIG. 2 and with the components shown in positions corresponding to the deck lid closed position.

FIG. 4 is a bottom plan view taken in the direction of the arrow 4 of FIG. 3.

FIG. 5 is a perspective view of the power operator and support bracket components shown in FIGS. 3 and 4.

FIG. 6 is an end elevational view of the mechanism of FIGS. 3-5 taken in the direction of the arrow 6 in FIG. 5.

FIG. 7 is an exploded perspective view of the components shown in FIGS. 3-6, the power operating mechanism and rack being shown separately from the associated hinge and support bracket components.

### DETAILED DESCRIPTION OF THE PREFERRED EMBODIMENT

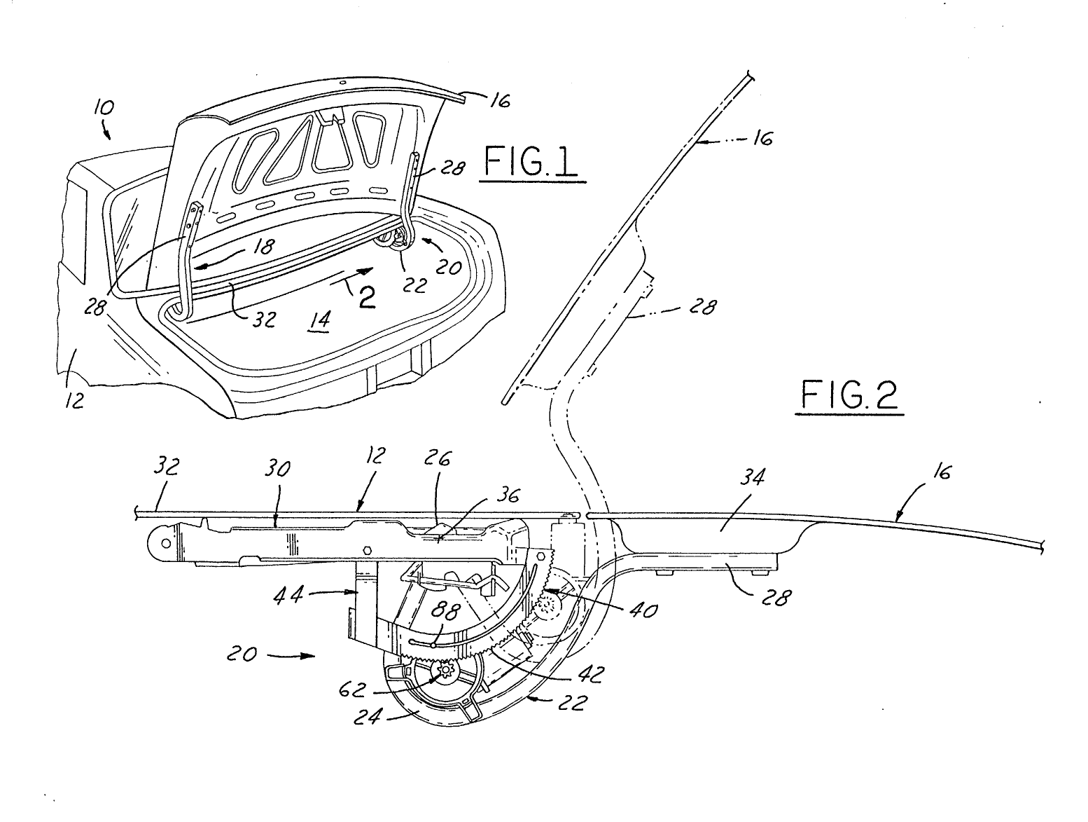

Referring in more detail to the accompanying drawings, FIG. 1 shows a motor vehicle 10 having a body 12 provided with a rear trunk space 14. Rear trunk deck lid 16 is pivotally supported on the vehicle body 12 by conventional port (left) and starboard (right) gooseneck hinge assemblies 18 and 20 for movement from an open position permitting access to the trunk space 14 to a closed position closing such access. FIG. 1 shows deck lid 16 fully open. FIG. 2 shows in solid lines deck lid 16 in closed position, and shows it in phantom lines in an almost fully open position.

Each gooseneck hinge assembly includes the usual gooseneck hinge arm 22 having the curved gooseneck section 24 that terminates at one end in a pivot pin bearing section 26, and that terminates at its other end in a straight deck lid mounting arm section 28. Pivot bearing section 26 receives a pivot pin (not shown) that is journal mounted in a conventional hinge support bracket 30 that in turn is suitably affixed in a conventional manner to the underside or interior side of the vehicle body sheet metal apron 32 that defines the forward edge of trunk space 14. The straight section 28 of each gooseneck hinge arm 22 is suitably affixed to a mounting platform 34 on the interior side of deck lid 16.

Gooseneck hinge assemblies 18 and 20 support deck lid 16 for pivotal movement about the coaxial axes of the pivot pins of these respective hinge assemblies, this pivot axis being shown at 36 in FIG. 32. Counterbalance forces for these hinge arms may be provided by a conventional torsion bar counterbalancing spring mechanism (not shown) installed on the underside of vehicle body apron 32 and spanning between and operably coupled to hinge assemblies 18 and 20.

The power operator assembly for swinging the deck lid about hinge axis 36 includes an elongated curved rack 40 having formed along one curved edge thereof a row of rack gear teeth 42. The forward end of rack 40 is welded to a sheet metal mounting bracket 44 that is fastened by a bolt 46 to the right side flange 48 of support bracket 30. The aft end of rack 40 is secured by a bolt 50 to a mounting tab 52 of support bracket 30. The rack teeth 42 of rack 40, when so mounted, extend in an arc concentric about pivot axis 36 of arm 22 on bracket 30.

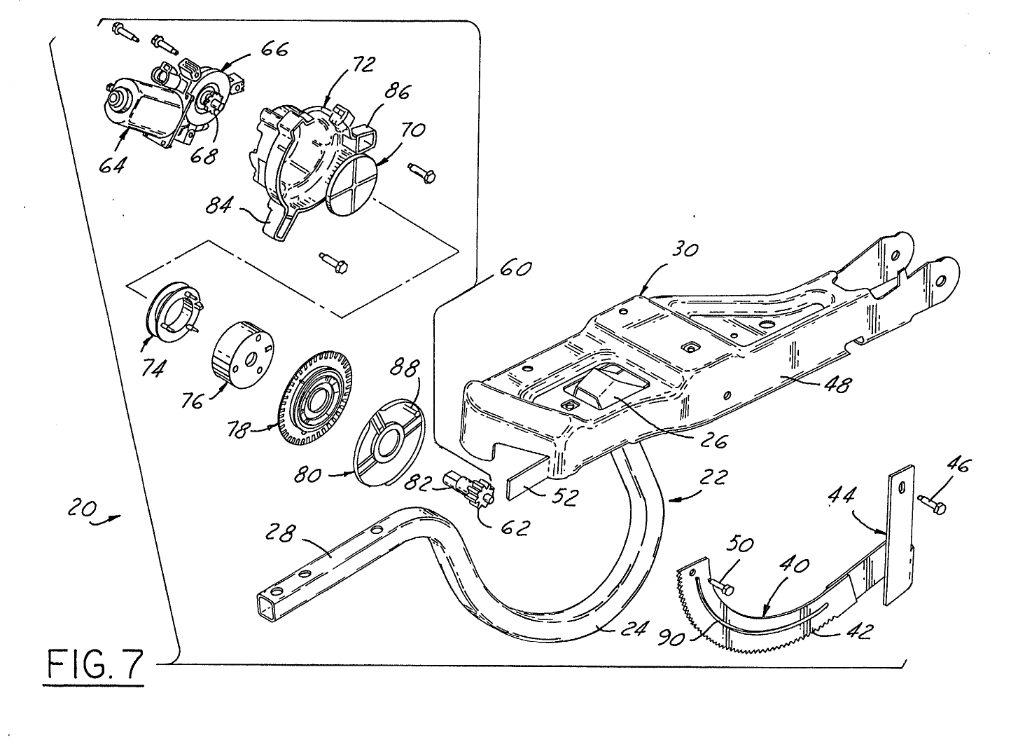

The deck lid power operator assembly also includes a power drive unit 60 (FIG. 7) that is mounted on gooseneck hinge arm 22 for swinging movement therewith. Unit 60 includes an output driving pinion 62 in driving mesh with rack gear teeth 42 so that rotation of pinion 62 is operable to move power unit 60 and the associated hinge arm 22 with a bodily swinging motion about axis 36 for opening and closing deck lid 16. Power unit 60 also includes a conventional reversible electric motor 64 and associated right angle gear reduction unit 66. An output pinion 68 of unit 66 drives a clutch gear 70 of a conventional electromagnetic clutch subassembly that is housed in a clutch housing 72. The clutch assembly includes conventional electromagnetic clutch parts 74 and 76 and an associated timing disk 78 contained in housing 72, and the housing is closed by a cover plate 80. The key shaft 82 of driver pinion 62 extends through cover 80 and timing disk 78 and into the driving engagement with part 76 of the clutch.

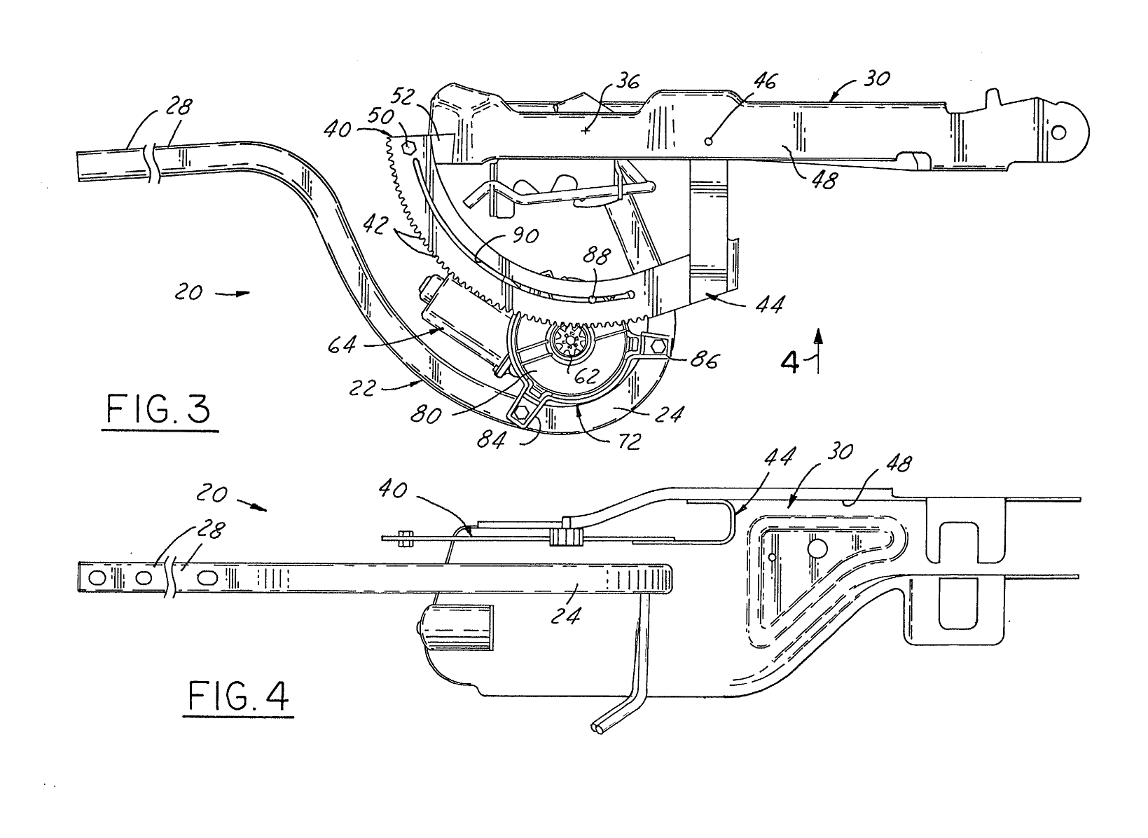

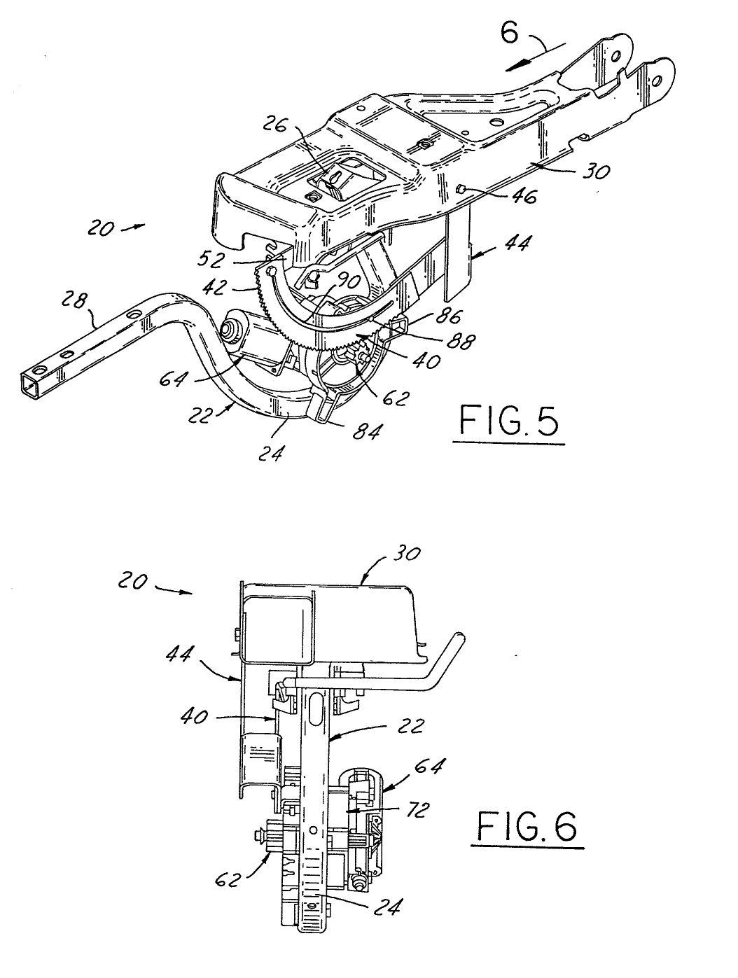

In accordance with the present invention, drive unit 60 is modified in two respects. Firstly, housing 72 is provided with mounting legs 84 and 86 that are oriented to fasten to the side of the curved section 24 of gooseneck hinge arm 22 as best seen in FIG. 3. Secondly, clutch cover plate 80 is provided with a piloting pin 88 (FIG. 7) that is mounted and oriented to extend through an arcuate guide slot 90 provided in rack 40. Pin 88 can slide in slot 90 and thereby serve as a keeper for retaining drive pinion 62 in driving mesh with rack teeth 42 throughout the operational travel of pinion 62 along the curved path of rack teeth 42.

Clutch unit 72-78 is normally in release position so that deck lid 16 can be opened and closed manually in the event of a power failure, but the clutch closes automatically in response to actuation of motor 64. The motor is actuated by a suitable control readily accessible to the operator of the vehicle, such, for example, as a hand-held fob (not shown) of the type used to carry the vehicle keys. The deck lid power control is conventional and is such that when the deck lid 16 is closed, operation of motor 64 rotates pinion 62 in one direction to move power unit 60 and arm 22 on which it is rigidly mounted in a curved path about the pivot axis 36 of the trunk lid to thereby open the deck lid. When the deck lid is to be closed the control is operable to reverse rotate the motor to thereby move the rack in the opposite direction.

From the foregoing description, it will be apparent to those of ordinary skill in the art that a deck lid power operator mechanism of the invention amply fulfills the aforestated objects and provides many advantages and features over the prior art. The apparatus of this invention has only two add-on subassemblies to the standard gooseneck hinge arm 22 and its supporting bracket 30, namely the rack 40 that easily mounts to bracket 30, and the power drive unit subassembly 60 that easily mounts to gooseneck hinge arm 22. If desired to facilitate assembly installation at the vehicle manufacturing facility, the entire power operator unit of the invention may be provided as a complete subassembly consisting of hinge arm 22, power drive unit 60 mounted thereon, support bracket 30 pivotably carrying hinge arm 22 and rack 40 fixed thereon by the brackets 44 and 52. When so provided the entire subassembly is readily mounted to the vehicle body and deck lid in the assembly line.

The orientation of rack 40 nested against the side and beneath support bracket 30 compactly places the same adjacent the normal swinging plane of hinge arm 22. Mounting of power drive unit 60 on the curved section 24 of hinge arm compactly nests this unit within the space normally reserved for the swinging motion of the gooseneck hinge arm. Thus, the power operator unit is compact and readily hidden from view, and does not occupy any additional storage space in the trunk compartment space 14.

It will also be understood that the power operator unit of the invention may be reversed in an alternate or modified arrangement wherein the power drive unit 60 becomes the stationary portion of the mechanism and thus is mounted by suitable bracketry to the support bracket 30, whereas rack 40 becomes a moving portion and thus is modified to be affixed to hinge arm 22. The rack teeth 42 are re-oriented to be on the inner peripheral edge of the moving rack and are drivingly engaged with the driving pinion 62 of the power drive unit when so mounted on support bracket 30.

Also, preferably only one hinge assembly (e.g., 20) need be power driven in the foregoing manner, with the other hinge assembly (e.g., 18) being slave-operated through the deck lid structure. However, if desired, each hinge assembly may have its own power operator, as by duplicating the power set-up of hinge assembly 20 in hinge assembly 18.

1. An apparatus for moving a deck lid of a vehicle body toward at least one of its open and closed positions relative to an associated vehicle compartment opening and wherein the deck lid is hinged to the vehicle body by a hinge assembly including port and starboard gooseneck hinge arms each having a curved section with a pivot mounting end and having a straight section joined to an end of the curved section opposite the pivot end thereof, each gooseneck arm straight section being fastened to the interior side of the deck lid and the pivot end of each gooseneck arm being pivotally mounted by an associated support bracket to the vehicle body whereby the deck lid is hinge-supported to swing about the pivot axis of the arms, the improvement in combination therewith of a deck lid power operator comprising:
a curved rack for at least one of said hinge arms fixed to one or the other of said one hinge arm support bracket and gooseneck curved section, said rack having a curved row of rack gear teeth arranged to extend in a curved path of constant radius concentric with the pivot axis of said one hinge arm, and a power unit mounted on the other one of said hinge arm support bracket and said gooseneck curved section, said power unit having a pinion in operable driving mesh with said rack gear teeth and operable upon rotation to cause relative movement of said rack and said power unit in a curved travel path parallel to said curved row of teeth to thereby move the deck lid toward one of its open and closed positions in response to such relative movement between said rack and said power unit.

2. The combination of claim 1 wherein said rack is stationarily fixed to said support bracket and said power unit is fixed to said gooseneck arm curved section such that said power unit is carried on and swings with said hinge arm in the travel path when said power operator is operated to cause the relative movement between said rack and said power unit.

3. The combination of claim 2 wherein said support bracket for said one hinge arm comprises a mounting platform fixed to the vehicle body forward of the vehicle compartment opening, said bracket having a journal mount structure for receiving a pivot pin for pivotal mounting of said pivot end of said hinge arm on said bracket, and wherein said rack is fixedly supported on said bracket.

4. The hinge combination of claim 3 wherein said power unit comprises a reversible electric motor, a gear reduction unit driven by said motor and an electromagnetic clutch unit including said pinion, and a housing enclosing said clutch unit and having spaced apart protruding arms fixedly mounted to said gooseneck curved section.

5. A deck lid power operator adapted for moving a deck lid of a vehicle body toward at least one of its open and closed positions relative to an associated vehicle compartment opening and wherein the deck lid is of the type that is hinged to the vehicle body by a hinge assembly including port and starboard gooseneck hinge arms each having a curved section with a pivot mounting end and having a straight section joined to an end of the curved section opposite the pivot end thereof, each gooseneck arm straight section being fastened to the interior side of the deck lid and the pivot end of each gooseneck arm being pivotally mounted by an associated support bracket to the vehicle body whereby the deck lid is hinge-supported to swing about the pivot axis of the arms, said deck lid power operator comprising:
a curved rack for at least one of the hinge arms adapted to be fixed to one or the other of the one hinge arm support bracket and gooseneck curved section, said rack having a curved row of rack gear teeth adapted to be arranged to extend in a curved path of constant radius concentric with the pivot axis of the one arm, and a power unit adapted to be mounted on the other one of the hinge arm support bracket and gooseneck curved section, said power unit having a pinion adapted for operable driving mesh with said rack gear teeth and adapted to be operable upon rotation to cause relative movement of said rack and said power unit in a curved travel path parallel to said curved row of teeth to thereby move the deck lid toward one of its open and closed positions in response to such relative movement between said rack and said power unit.

6. The deck lid power operator of claim 5 wherein said rack is adapted to be stationarily fixed to the support bracket and said power unit is adapted to be fixed to the gooseneck arm curved section such that said power unit is adapted to be carried on and swings with the hinge arm in the travel path when said power operator is operated to cause the relative movement between said rack and said power unit.

7. The deck lid power operator of claim 6 wherein the support bracket for the one hinge arm is of the type comprising a mounting platform fixed to the vehicle body forward of the vehicle compartment opening, the bracket having a journal mount structure for receiving a pivot pin for pivotal mounting of the pivot end of the hinge arm on the bracket, and wherein said rack is adapted to be fixedly supported on the bracket.

8. The deck lid power operator of claim 7 wherein said power unit comprises a reversible electric motor, a gear reduction unit driven by said motor and an electromagnetic clutch unit including said pinion, and a housing enclosing said clutch unit and having spaced apart protruding arms adapted to be fixedly mounted to said hinge gooseneck curved section.

9. The deck lid power operator of claim 8 wherein said rack has a guide slot extending in a path concentric with the pivot axis of the hinge arms, and said power unit includes a guide pin fixed thereto and extending through said slot in said rack for guiding said power unit in travel along said rack and for keeping said pinion in operable mesh with the teeth of said rack during operation thereof.

10. The deck lid power operator of claim 6 wherein said power unit includes an electromagnetic clutch unit driven by said motor and gear reduction unit and having a housing with spaced arms for mounting said housing on said gooseneck hinge arm.
